(19) United States
(12) Patent Application Publication
(10) Pub. No.: US 2014/0108421 A1
(43) Pub. Date: Apr. 17, 2014

(54) PARTITIONING DATABASE DATA IN A SHARDED DATABASE

(71) Applicant: CODEFUTURES CORPORATION, BROOMFIELD, CO (US)

(72) Inventors: Cory M. Isaacson, Broomfield, CO (US); Andrew F. Grove, Broomfield, CO (US)

(73) Assignee: CODEFUTURES CORPORATION, BROOMFIELD, CO (US)

(21) Appl. No.: 14/046,875

(22) Filed: Oct. 4, 2013

Related U.S. Application Data
(60) Provisional application No. 61/709,972, filed on Oct. 4, 2012.

(51) Int. Cl. G06F 17/30

(52) U.S. Cl. CPC G06F 17/3033
USPC 707/747

(57) ABSTRACT

A sharded database system configured for partitioning data amongst a plurality of shard servers is provided. In one implementation the sharded database system comprises a sharded database including a first shard server, a second shard server, and a shard control record. The shard control record is configured to define a first data structure for distributing a first plurality of data records or rows based on a first sharding by monotonic key range across the first and second shard servers. The sharded database is also configured to further distribute the first plurality of records or rows across the first shard server and the second shard server via a subsidiary hashing method. A method of partitioning data of a database is also provided.

### CROSS-REFERENCE TO RELATED APPLICATIONS

This application claims the benefit of U.S. provisional application No. 61/709,972, filed Oct. 4, 2012, which is hereby incorporated by reference as though fully set forth herein.

### BACKGROUND

a. Field

The instant invention relates to a partitioning data in a sharded database.

b. Background

In database management systems for transaction or data warehouse storage, retrieval and processing of data, data size and concurrent transaction volume is limited on a single server or machine. A common approach to solve this problem is to use database sharding (partitioning) of data across multiple servers with a shared nothing environment in which independent servers do not share data. In such a data partitioning scheme, data is partitioned by a key value (a specific field or column from a record or row), using one of various methods for key distribution across a plurality of servers.

Key distribution using various methods is performed to provide a predictable grouping of records on a specific server, enabling access to the proper server for any given key. In previous designs, several key distribution methods have been used. These methods are called hashing methods for predictable distribution of read and write access to the records on the shard servers. The common methods for key distribution are:
(1) Modulus: Use a simple modulus numeric function on a key value, based on the number of servers available, and distribute reads and writes accordingly. This method is effective for storing and retrieving information, but has the drawback of requiring massive movement of all database data when servers are added or removed from a distributed cluster.
(2) Consistent Hashing: A more sophisticated hash wherein a large number of hash ranges are evenly distributed across servers. Each range stores a chunk of records, based on a hash of key values that fit within the range of a given server. When servers are added, chunks of records can be slowly migrated, reducing the amount of data movement as servers are added to or removed from the cluster.
(3) Monotonic Hashing: When key values are monotonic, new key values are either always increasing or always decreasing (always increasing for the purposes of implementations described herein). This allows the creation of fixed key ranges that never (or rarely) change throughout the life of the database sharding system, eliminating (or greatly reducing) the need for data redistribution as servers are added or removed. Monotonic Hashing also allows any number of new shard servers to be added to a shard environment, matching the expected load.

Prior methods focus on automatically distributing keys for each type of record in a database. This leads to a high percentage of distributed operations, meaning that it is often required to read from, or write to a number of servers to perform a single operation. For example, reading a list of Customer Order records for a single Customer in an order management system could require accessing each Customer Order record from a separate shard server, increasing the number of operations and correspondingly slowing down the performance of the distributed database system. Further data redistribution is a highly expensive operation, as when servers are added or removed to the sharding system, each individual record type must be redistributed according to the hashing mechanism used. Distributed operations in a sharded system are typically slower than those of a single monolithic database system, defeating the purpose of a database sharding system.

Further joins are extremely inefficient in this method, as related records or rows must be retrieved from disparate servers across the network, and re-assembled into a proper join in memory or on disk, adding even more overhead to a sharded system.

### BRIEF SUMMARY

In one implementation, a sharded database system configured for partitioning data amongst a plurality of shard servers is provided. The sharded database system comprises a sharded database including a first shard server, a second shard server, and a shard control record. The shard control record is configured to define a first data structure for distributing a first plurality of data records or rows based on a first sharding by monotonic key range across the first and second shard servers. The sharded database is also configured to further distribute the first plurality of records or rows across the first shard server and the second shard server via a subsidiary hashing method.

In another implementation, a method of partitioning data of a database is also provided. In one implementation of such a method, the method comprises: defining a first shard control record for a first shard server and a second shard server of a database, the first shard control record defining a first data structure for distributing a first plurality of data records or rows based on a first sharding by monotonic key range across the first and second shard servers; distributing records or rows within the first and second shard servers via a subsidiary hashing method; adding a third shard server after the first plurality of data records or rows are added to the first and second shard servers of the database; and updating the shard control record to define a second data structure for distributing a second plurality of data records or rows based on a second sharding by monotonic key range across the first, second and third shard servers.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 depicts an example implementation of a sharded database system.

FIG. 2 depicts an example implementation of a time series illustrating monotonic hashing in a sharded relational database.

FIG. 3 depicts an example implementation of a data structure utilizing monotonic key range hashing within a sharded relational database.

FIG. 4 depicts an exemplary system useful in implementations of the described technology.

### DETAILED DESCRIPTION

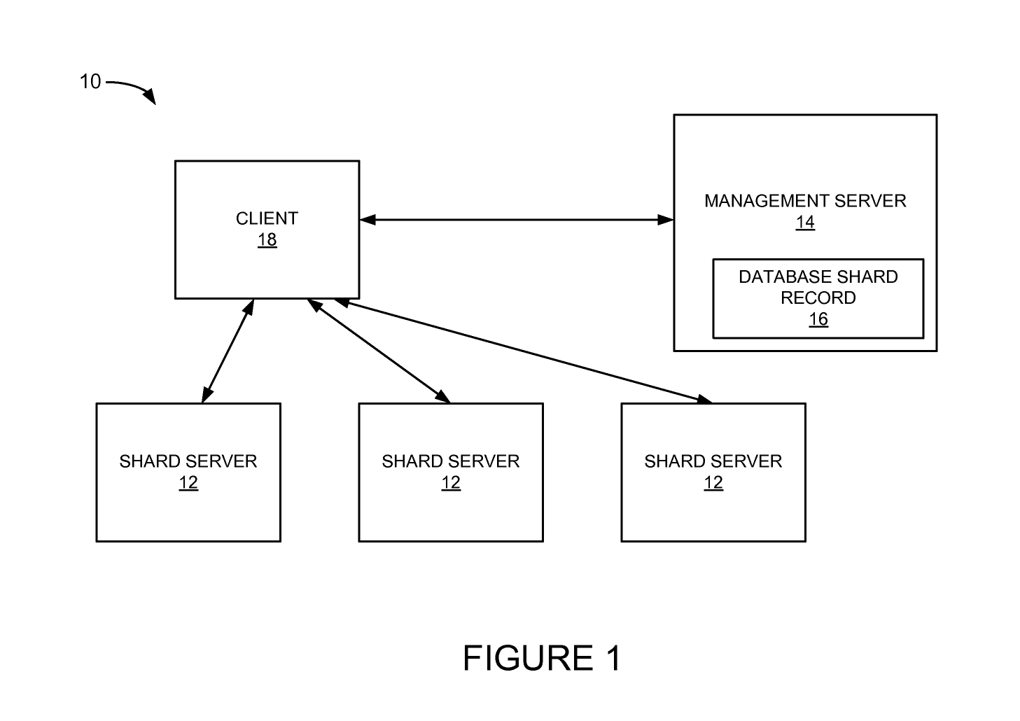

FIG. 1 depicts an example implementation of a sharded database system 10 (e.g., a sharded relational database system). The sharded database system comprises a plurality of shard servers 12 and a management server 14. Although three shard servers are shown, any number of shard servers may be used. The management server 14, among other functionalities of a database system, includes a database shard record 16 that defines a data structure for distributing a plurality of data records or rows based on a sharding by monotonic key range across the plurality of shard servers. Data records or rows are also distributed within the plurality of shard servers via a subsidiary hashing method, such as but not limited to modulus or consistent hashing. Although a separate management server 14 is depicted, the functionalities can be housed in one or more of the shard servers or in another server. In the particular implementation shown in FIG. 1, a client 18 accesses the database shard record 16 via the management server 14 and reads and writes to the sharded database system 10 via individual shard servers 12.

One objective of a sharded system is to have the highest possible percentage of single shard read and single shard write operations for a given application, which fulfill the database query needs for that application, and the lowest possible percentage of distributed read and write operations. The ratio of single shard read and write operations to distributed operations is directly proportional to the efficiency and scalability of a sharded system. For example, a database sharding system with 100% single shard read and single shard write operations is a shared nothing system, and will scale linearly (or better) as servers are added to the database sharding system. In contrast, a database sharding system with 50% distributed operations, and 50% single server read and single server write operations, will exhibit significant performance degradation, due to the high frequency of sending records over the network and of joining those records or recreating lists of related records (such as a list of orders for a single customer). In short, keeping the ratio of single server read and single server write operations as close to 100% as possible, and keeping distributed operations as close to 0% is an objective of an efficient, scalable database sharding system.

Implementations provided herein use a technique for automating a database sharding scheme with a combination of Monotonic Key Hashing or Consistent Hashing plus a technique called Relational Sharding. Relational Sharding partitions data tables according to record relationships that fit an application's natural search path, storing related data records on the same server. This increases the percentage of single-server read and single-server write operations, and minimizes the probability of distributed operations, while fulfilling application data storage and retrieval requirements. Further, as the database sharding system expands, these implementations eliminate or at least significantly reduce the need for data redistribution in most cases, and when data redistribution is required, minimizes or at least reduces the quantity of data that must be moved, effectively addressing the most costly operation in such a system.

In some implementations, Relational Sharding is based on a Shard Tree, a group of related tables in a relational database system, or any other database system where data relationships can be understood, defined or expressed. A Shard Tree has a Root Shard Table, the parent of the Shard Tree. Related individual records or rows in a Shard Tree are always sharded using the key of the Root Shard Table, thus all related rows are stored in the same shard. The data relationships that define the Shard Tree are application specific, and are discovered through an automated tool or specified by an application developer. Relational Sharding increases the probability that application data requests can be satisfied with single shard read and write operations, while minimizing the probability of distributed operations. Therefore Relational Sharding is more efficient and performs much better than other automated sharding systems that treat each table independently of another.

In one implementation, a Shard Index can be used to determine the Shard Key for a grandchild table, such as Order Line. The Shard Index will contain an index from the Primary key of the table to the Shard Key, when the Shard Key is not present in the grandchild table. The Shard Index can be sharded across a number of servers using the same distribution mechanisms as the actual shard tables, based on Modulus, Consistent Hashing, or Monotonic hashing for the Prmary key value.

Some implementations use Modulus, Monotonic Hashing or Consistent Hashing to distribute data records or rows, using the Shard Key of the Root Shard Table. The Shard Key is a specific field or column in the Root Shard Table, such as a Customer ID in a Customer table. Each child or grandchild table in the Shard Tree is sharded using the same key as the Shard Root table. For example, in a simple Shard Tree with 3 tables: Customer, Customer Order and Order Line, there are 3 relationships. Each table has its own Primary Key to uniquely identify a given record or row, and a child or grandchild table has a Foreign Key that references its immediate parent record or row. Using the Primary and Foreign Key values to establish relationships, and thus determine the proper shard, keeps all related records or rows for a given record or row in the Shard Root table. Each other key in the Shard Root table, and all of its child or grandchild records or rows are similarly distributed and grouped together on individual shards.

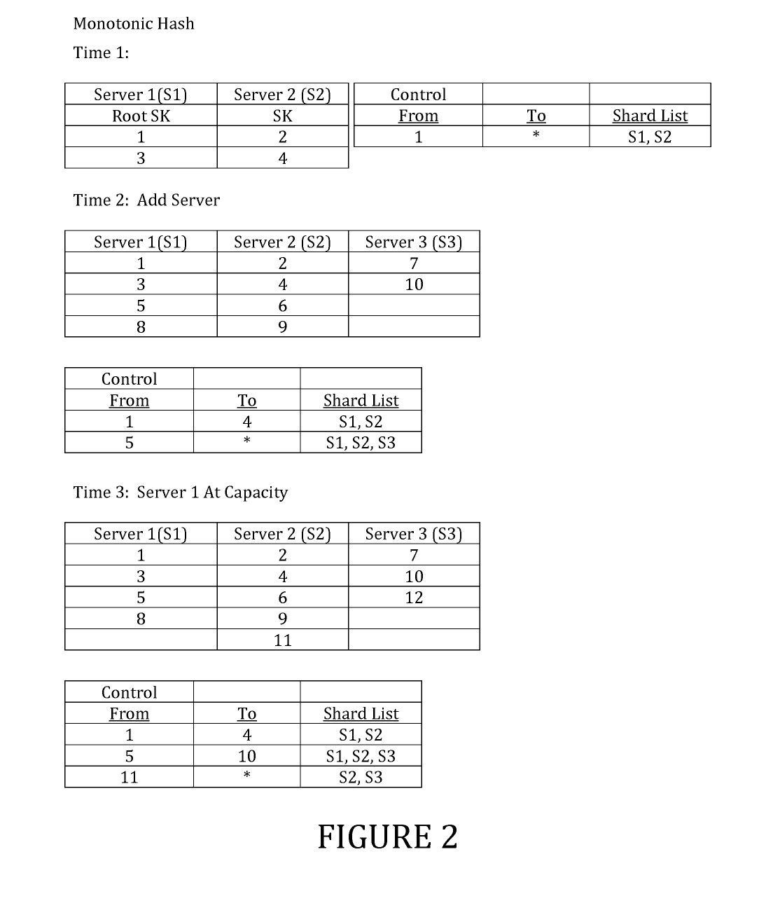

FIG. 2 shows an example implementation of a sharded database system in which a shard root table is partitioned based on a monotonic range hashing method using a shard tree on a root shard key. In one implementation, for example, all child and grandchild tables are sharded by root. In this implementation, a greater percentage of single shard read/write operations is provided, and the relational structure uses monotonic range sharding and re-sharding is needed less. If required, all related rows can be moved into a tree for a root shard key.

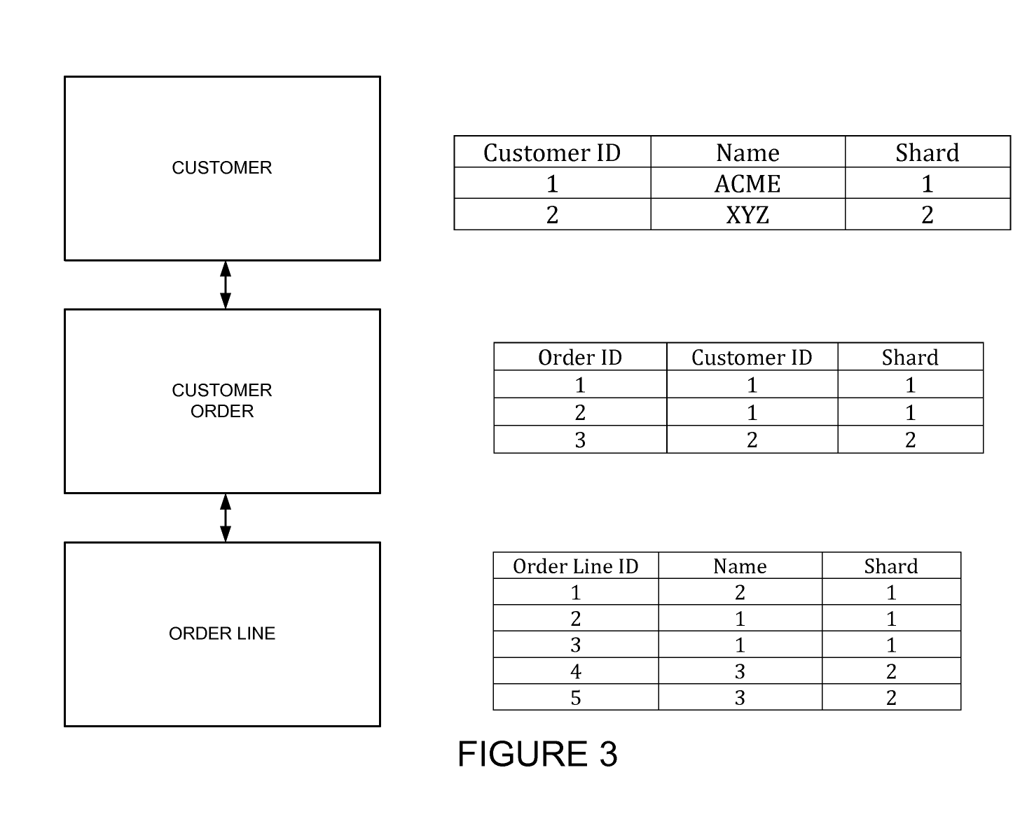

In one implementation, for example, a shard root table is partitioned based on a monotonic range hashing method (see FIG. 2). In this implementation a shard control record includes a range of shard key values allocated to a given configuration of shard servers in a given time period. In a subsequent time period, as other shard servers are added, a new shard control record is added to define the new sharding scheme for a higher range of shard root table key values. The following describes one example of a series of time events as shown in FIG. 2 and the data structure shown in FIG. 3:
Time Period 1: The system starts with 2 shard servers, S1 and S2. A Shard Control record is defined, stating that for Customer ID values in the range from 1 to N (an undefined upper limit), the records or rows will be evenly distributed across S1 and S2 using a subsidiary hashing method. Any child and grandchild records or rows in the Customer Order and Order Line tables are also distributed to the same shard as the related Customer ID value for any given Customer record or row.
Time Period 2: A new shard server is added, S3 after 4 Customer records or rows have been added to the system, with Root Shard table Shard Key values in the range of 1 to 4. The first Shard Control record is updated to state that the range of key values between 1 and 4 are to be distributed over S1 and S2 using a subsidiary hashing method. A new Shard Control record is added that defines a Shard Key range of 5 to N (undefined upper limit), distributing all records or rows with a key value in this new range across S1, S2, and S3.
Time Period 3: The S1 shard server reaches its capacity for Customers, allowing for expected growth in child and grandchild records or rows of the Customer records that have already been stored on S1. No new Customer records or rows will be added to S1, after 10 Customer records or rows have been added to the system, with Shard Key values of 1-10. The second Shard Control record is updated to define the shard key range of 5-10, with records or rows distributed across S1, S2, and S3 using a subsidiary hashing method. A new Shard Control record is added, defining a Shard Key range of 11 to N (undefined upper limit), distributing new Customer records or rows across S2 and S3 using a subsidiary hashing method. No new Customer records or rows are ever added to S1, but new child or grandchild records or rows can be added to S1, so long as it has capacity.

Using this combination of monotonic key range hashing and a subsidiary hashing method, such as modulus or consistent hashing, to implement relational sharding, the objectives of the highest ratio of single shard read and single shard write operations, while minimizing distributed operations is achieved. In addition, this combination eliminates or greatly reduces the possibility of the requirement to redistribute or re-shard the records or rows as the shard system expands.

Relational sharding can also be used with only modulus or consistent hashing methods of shard key distribution. In these cases, the same benefit for the highest possible ratio of single shard read and single shard write operations is maintained. With these distribution methods, the redistribution or re-sharding requirements are the same as in other comparable systems.

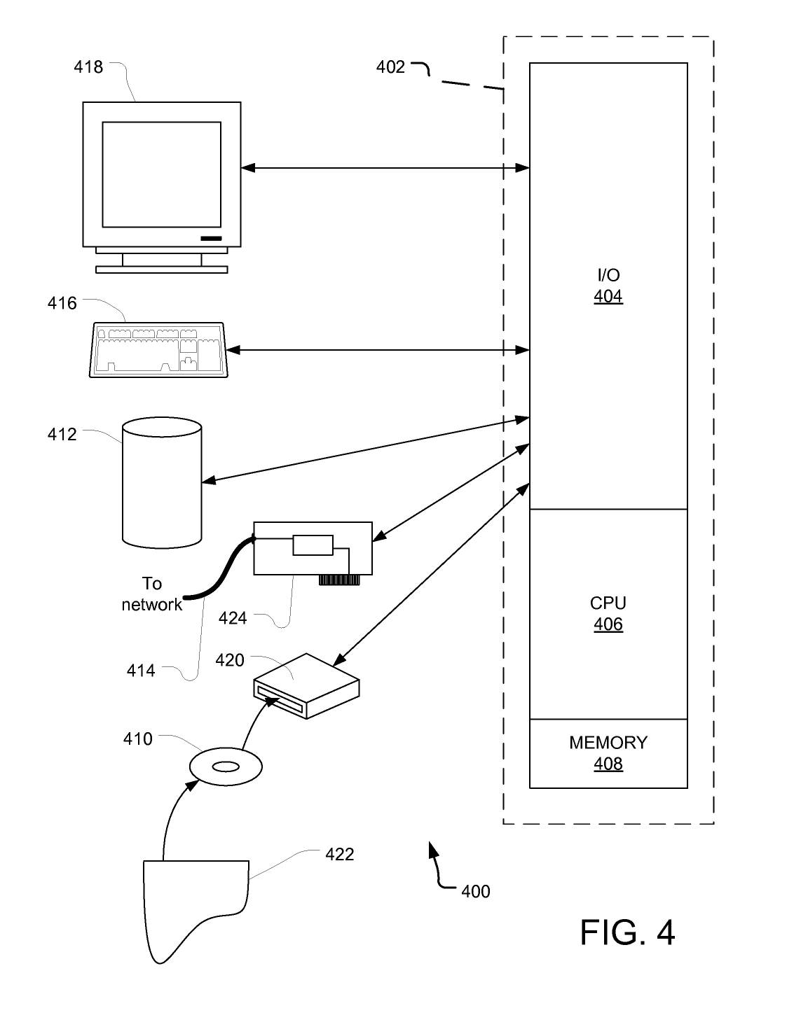

FIG. 4 illustrates an exemplary system useful in implementations of the described technology. A general purpose computer system 400 is capable of executing a computer program product to execute a computer process. Data and program files may be input to the computer system 400, which reads the files and executes the programs therein. Some of the elements of a general purpose computer system 400 are shown in FIG. 4 wherein a processor 402 is shown having an input/output (I/O) section 404, a Central Processing Unit (CPU) 406, and a memory section 408. There may be one or more processors 402, such that the processor 402 of the computer system 400 comprises a single central-processing unit 406, or a plurality of processing units, commonly referred to as a parallel processing environment. The computer system 400 may be a conventional computer, a distributed computer, or any other type of computer. The described technology is optionally implemented in software devices loaded in memory 408, stored on a configured DVD/CD-ROM 410 or storage unit 412, and/or communicated via a wired or wireless network link 414 on a carrier signal, thereby transforming the computer system 400 in FIG. 4 to a special purpose machine for implementing the described operations.

The I/O section 404 is connected to one or more user-interface devices (e.g., a keyboard 416 and a display unit 418), a disk storage unit 412, and a disk drive unit 420. Generally, in contemporary systems, the disk drive unit 420 is a DVD/CD-ROM drive unit capable of reading the DVD/CD-ROM medium 410, which typically contains programs and data 422. Computer program products containing mechanisms to effectuate the systems and methods in accordance with the described technology may reside in the memory section 404, on a disk storage unit 412, or on the DVD/CD-ROM medium 410 of such a system 400. Alternatively, a disk drive unit 420 may be replaced or supplemented by a floppy drive unit, a tape drive unit, or other storage medium drive unit. The network adapter 424 is capable of connecting the computer system to a network via the network link 414, through which the computer system can receive instructions and data embodied in a carrier wave. Examples of such systems include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 400 is connected (by wired connection or wirelessly) to a local network through the network interface or adapter 424, which is one type of communications device. When used in a WAN-networking environment, the computer system 400 typically includes a modem, a network adapter, or any other type of communications device for establishing communications over the wide area network. In a networked environment, program modules depicted relative to the computer system 400 or portions thereof, may be stored in a remote memory storage device. It is appreciated that the network connections shown are exemplary and other means of and communications devices for establishing a communications link between the computers may be used.

In accordance with an implementation, software instructions and data directed toward caching and aggregating data may reside on disk storage unit 409, disk drive unit 407, memory (e.g., RAM, DRAM, ROM, flash etc.) or other storage medium units in one or more computer systems of a system or coupled to the system. Software instructions may also be executed by CPU 406. It should be understood that processors on other devices may also execute the operations described herein.

In various implementations, a computer program may also be provided in which various operations or steps described herein are performed by the computer program.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the description.

The above specification, examples and data provide a complete description of the structure and use of exemplary embodiments of the invention. Since many embodiments of the invention can be made without departing from the spirit and scope of the invention. Furthermore, structural features of the different embodiments may be combined in yet another embodiment without departing from the invention.

Although various implementations of this invention have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A sharded database system configured for partitioning data amongst a plurality of shard servers, the system comprising:
a sharded database comprising a first shard server, a second shard server, and a shard control record configured to define a first data structure for distributing a first plurality of data records or rows based on a first sharding by monotonic key range across the first and second shard servers, wherein the sharded database is configured to further distribute the first plurality of records or rows across the first shard server and the second shard server via a subsidiary hashing method.

2. The sharded database system of claim 1 wherein the first sharding is based on a shard tree.

3. The sharded database system of claim 2 wherein the shard tree comprises a root shard table.

4. The sharded database system of claim 3 wherein the root shard table comprises a parent of the shard tree.

5. The sharded database system of claim 2 wherein the shard tree comprises application specific data relationships.

6. The sharded database system of claim 5 wherein the data relationships are discovered via an automated tool.

7. The sharded database system of claim 5 wherein the data relationships are specified by an application developer.

8. The sharded database system of claim 1 wherein the sharded database comprises a shard index.

9. The sharded database system of claim 8 wherein the sharded database is configured to determine a shard key using the shard index.

10. The sharded database system of claim 9 wherein the sharded database is configured to determine the shard key for a grandchild table using the shard index.

11. The sharded database system of claim 1 wherein the subsidiary hashing method comprises modulus hashing.

12. The sharded database system of claim 1 wherein the subsidiary hashing method comprises consistent hashing.

13. A method of partitioning data of a database, the method comprising:
defining a first shard control record for a first shard server and a second shard server of a database, the first shard control record defining a first data structure for distributing a first plurality of data records or rows based on a first sharding by monotonic key range across the first and second shard servers;
distributing records or rows within the first and second shard servers via a subsidiary hashing method;
adding a third shard server after the first plurality of data records or rows are added to the first and second shard servers of the database; and
updating the shard control record to define a second data structure for distributing a second plurality of data records or rows based on a second sharding by monotonic key range across the first, second and third shard servers.

14. The method of claim 13 further comprising distributing records or rows within the first, second and third shard servers via the subsidiary hashing method after the operation of updating the shard control record to define a second data structure for distributing a second plurality of data records or rows.

15. The method of claim 13 further comprising updating the shard control record to define a third data structure for distributing a third plurality of data records or rows across the second and third shard servers.

16. The method of claim 15 wherein the operation of updating the shard control record to define the third data structure restricts new data records or rows from being stored in the first shard server.

17. The method of claim 13 wherein the subsidiary hashing method comprises modulus hashing.

18. The method of claim 13 wherein the subsidiary hashing method comprises consistent hashing.

19. The method of claim 13 wherein the plurality of data records or rows comprises a plurality of relational data rows.
